(19) United States
(12) Patent Application Publication
(10) Pub. No.: US 2005/0074053 A1
(43) Pub. Date: Apr. 7, 2005

(54) Method and system for providing security on a network

(76) Inventors: Robert Q. Daniel, Great Falls, VA (US); Jiang David Zhu, N. Potomac, MD (US)

Correspondence Address: HOFFMAN, WASSON & GITLER, P.C., Suite 522, 2361 Jefferson Davis Highway, Arlington, VA, 22202, US

(21) Appl. No.: 10/677,266

(22) Filed: Oct. 3, 2003

(51) Int. Cl. H04B 1/69

(52) U.S. Cl. 375/141

(57) ABSTRACT

A system and method for providing security and network management, as well as for increasing the performance in a communication system. A master agent unit is provided in the communication system along with a number of slave units. One or more spreading sequences would be generated by the master agent and securely sent to each of the slave agents in the communication system. The spreading sequence would be changed by the master agent periodically or nonperiodically. The spreading sequence would be used by each of the slave agents for communication in the communication system or network.

### BACKGROUND OF THE INVENTION

1. Field of the Invention

The present invention is directed to the field of communications in which a number of network devices are designed to communicate with each other in a manner in which non-authorized users would be excluded from the communication system.

2. Prior Art Systems

Various prior art communication systems are illustrated with respect to FIGS. 1-5. These systems, while allowing communication between different users in the system, are not particularly secure and would allow unauthorized users to intercept various communication messages sent by authorized users in the system. It is noted that the systems shown in FIGS. 1-5 are intended to illustrate typical prior art systems and not intended to be a complete list of the prior art systems in this field.

For example, FIG. 1 describes a system 10 utilizing a traditional cryptography scenario. In this instance, plain text is generated and sent to an encryption device 12 to be encrypted using an encryption key stream. The encryption device 12 would then create a cipher text which is transmitted to a remote location which is then decrypted in a decryption device 14 utilizing the same encryption key stream used to create the ciphered text. This decrypted message would result in the regeneration of the plain text message.

FIG. 2 illustrates a code division multiple access (CDMA) system 16 utilizing a spreading sequence instead of an encrypted key stream. In this system, the plain text is created and sent to a device 18 for applying a spreading sequence to the plain text resulting in the creation of a spread signal. This spread signal is transmitted to a remote receiver including a device 20 for despreading the spread signal utilizing the same spreading sequence used to create the spread signal. This would result in the production of the plain text. It is important to note that the CDMA communications system illustrated in FIG. 2 would generally employ a spreading sequence despreading hard wired into both the transmission device, as well as the receiving device. The use of this hard wired spreading sequence would make it very difficult to quickly and easily change the spreading sequence.

The system 23 illustrated in FIG. 3 combines the traditional cryptography system shown in FIG. 1 with the CDMA communication system illustrated in FIG. 2. In this system, plain text would be created and sent to an encryption device 24 in which an encryption key stream would produce a cipher text message. This cipher text message would then be transmitted to a device 26 in which a spreading sequence would be used to create a spread signal, including the ciphered text. This spread signal, including the ciphered text, would be transmitted to a remote receiver containing a despreading device 28 in which the same spreading sequence used to create the spread signal would be used to despread the signal for the purpose of producing the same ciphered text created by the transmitter. This ciphered text would be, in turn, be sent to a decryption device 30 located in the receiver used to produce the plain text employing the same encryption key stream as was utilized by the transmitter. Similar to the system described in FIG. 2, the system of FIG. 3 would generally employ a spreading and despreading sequence hard wired into both the transmitter and the receiver, thereby making it very difficult to change the spreading sequence from a first unique spreading sequence to a second or multiple spreading sequences.

FIG. 4 illustrates a system 32 utilizing a unique key to generate the spreading sequence. Either plain text or cipher text would be sent to a spreading device 34 employing a spreading sequence generator 38 utilizing a unique key to generate the spreading sequence. Consequently, the spread signal generated by the device 34 would be transmitted to a remote receiver including a despreading device 36. This despreading device would include a despreading sequence generator 40 controlled by a unique key to produce the plain text or ciphered text. However, as indicated with respect to the systems illustrated in FIGS. 2 and 3, the spreading and despreading sequences would be hard wired into both the transmitter and the receiver.

A typical network utilizing the prior teachings shown in FIGS. 1-4 is depicted in FIG. 5. In this instance, FIG. 5 shows a wireless local area network (WLAN) such as the popular 802.11b WLAN for transmitting and receiving data between a number of units in the communication network. Typical of these units would be a master device 46, a plurality of work stations 46, 48, 50 and 52, as well as other types of devices such as a PDA 56, as well as mobile personal computers 54 and 58. Obviously, it is noted that this communication system 42 could include other, and more numerous, components. When used in a CDMA communication system, the spreading sequence could be a known 11 bit fixed Barker code. The encryption and decryption are done with a standard wireless encryption protocol (WEP). The WEP is considered as a weak encryption scheme and messages transmitted from one of the devices in system 42 to another device or devices in the system 42 can be intercepted and decrypted without great effort. As described with the prior art systems illustrated previously, the spreading and despreading sequences are fixed permanently in the hardware and would be used only to provide process gain, but not used to provide security or isolation for the network communication. Furthermore, radio frequency (RF) interference from adjacent WLANs can be problematic for the network communication when multiple WLANs exist in close proximity to each other.

### SUMMARY OF THE INVENTION

The problems encountered in the prior art relating to the security of transmitted messages within a communication system, as well as problems resulting from interference created by other communication systems are addressed by the present invention.

The present invention is directed to a communication system and method of transmitting messages within the communication system utilizing a master agent to control a security system employed in the generation and transmission of these messages by so-called slave agents in the system. The master agent would be provided with a device for generating and securely transmitting a unique spreading sequence to the slave agents contained in the communication system using asymmetric or symmetric cryptography. These slave agents would receive this unique spreading sequence and maintain the spreading sequence in a memory device. Thereafter, messages generated by each of the slave agents would use that unique spreading sequence to transmit messages to other slave agents in the communication system. It is important to note that the spreading sequence generated by the master agent is neither hard wired in the master agent, nor in any of the slave agents. Rather, the spreading sequence would be provided within a memory included in the master agent, as well as all of the other slave agents. It can therefore be appreciated that this spreading sequence can be easily changed by the master agent by transmitting a new spread sequence from the master agent to the slave agents, either on a periodic basis (i.e., once an hour, once a day, once a week, etc.) or on a nonperiodic basis. Consistent with the master agent producing a spreading sequence on a nonperiodic basis, this spreading sequence could be necessitated by one or more of the slave agents being removed from the communication system either by the master agent or by one or more of the slave agents voluntarily leaving the system. Consequently, once a communication is transmitted from one slave agent to a second or plurality of slave agents, the received communication, whether it is ciphered or not, would be despread by the slave agents using the particular spread sequence currently being used by the system.

Utilizing the unique spreading sequences, as well as the keys that generate each of the spreading sequences, a communication system would be created achieving high security, efficient usage of the bandwidth, little or no intentional/unintentional interference and flexible network management.

Other objects of the present invention will be apparent from the following description and the accompanying drawings.

### BRIEF DESCRIPTION OF THE DRAWINGS

FIG. 1 is a block diagram of a prior art communication system utilizing traditional cryptography;

FIG. 2 is a block diagram of a prior art CDMA communication system employing a spreading sequence;

FIG. 3 is a block diagram of a traditional cryptography system utilizing the CDMA communication system;

FIG. 4 is a block diagram showing a prior art communication system utilizing a spreading sequence created by a key;

FIG. 5 illustrates a prior art WLAN system;

FIG. 6 illustrates a communication system utilizing the teachings of the present invention;

FIG. 7 is a block diagram of the master agent used by the present system;

FIG. 8 is a block diagram showing the components of a slave agent;

FIG. 9 shows a communication system having a secure subnet with multiple spreading sequences;

FIG. 10 shows a second communication system having secure subnets;

FIG. 11 illustrates multiple WLANs in close vicinity to one another;

FIG. 12 illustrates secure interconnected WLANs;

FIG. 13 is a block diagram showing the operation of a typical master agent; and

FIG. 14 is a block diagram showing the operation of a typical slave agent.

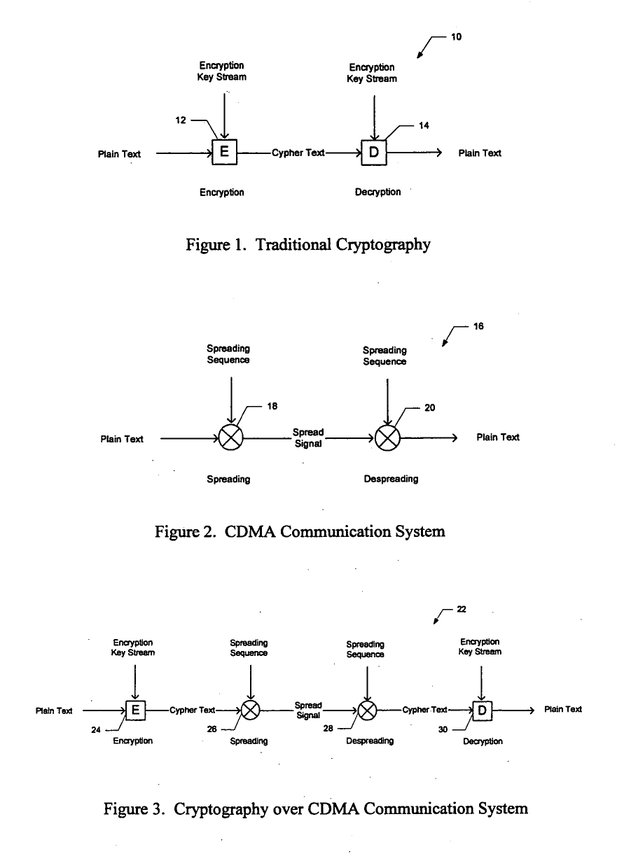

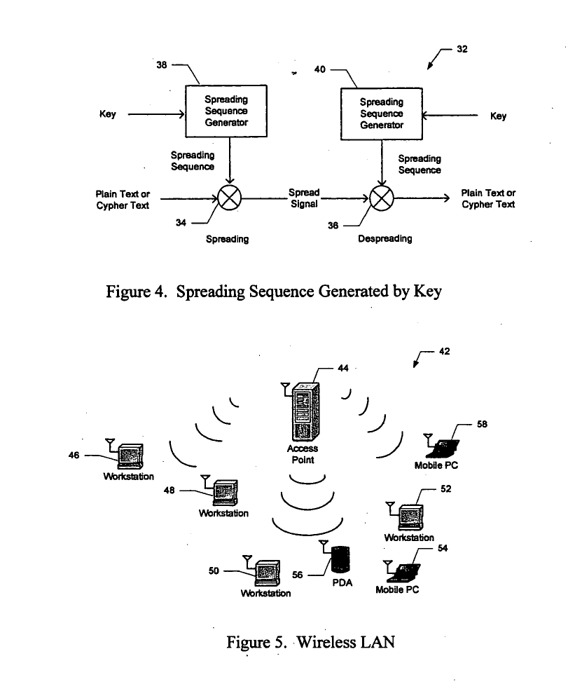

### DETAILED DESCRIPTION OF THE PRESENT INVENTION

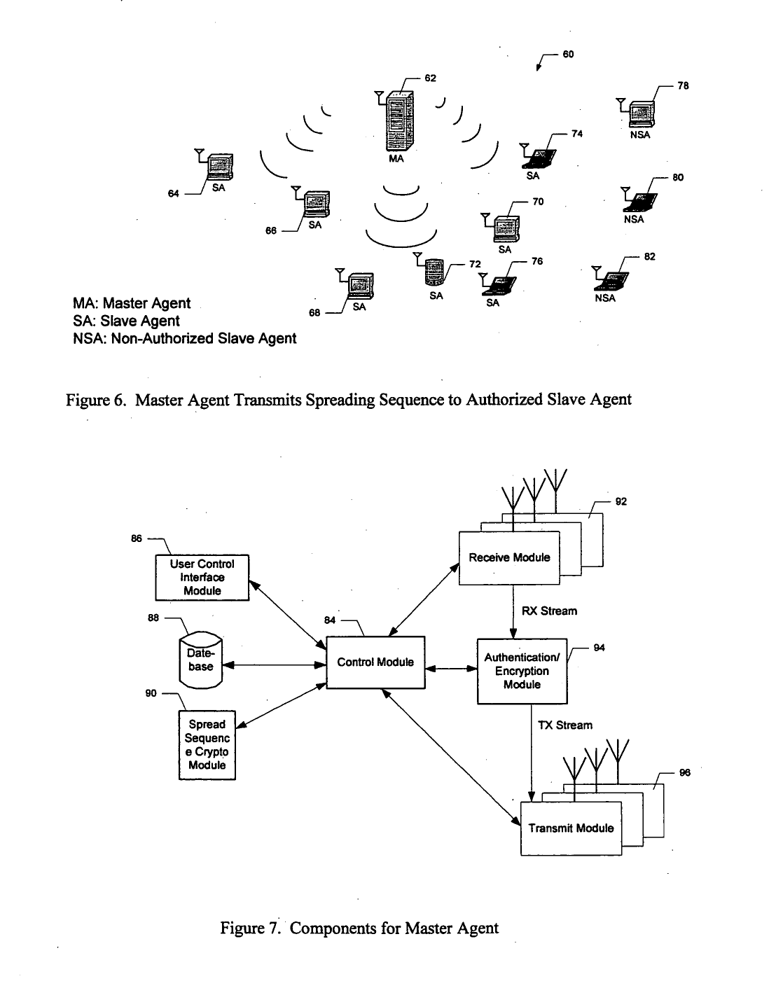

FIG. 6 illustrates one embodiment of the present invention provided with a system 60 allowing secured transmission between the various authorized members of a communications network. This network includes a master agent 62 which generates and transmits a spreading sequence to be received by all of the authorized or slave agents of the system 60. These slave agents are the network devices and would include work stations 64, 66, 68 and 70, as well as a PDA 72 and mobile PCs 74 and 76. It can be appreciated that the system illustrated in FIG. 6 could include other types of wireless communication devices. The master agent 62 would generate a spreading sequence as will be subsequently explained to be received and stored by each of the slave agents. These slave agents would contain software and/or hardware devices capable of receiving, storing and utilizing the spreading sequence generated and transmitted by the master agent 62 in communications between other authorized slave agents in the system 60. Transmission between each of the authorized slave agents, once they have acquired the spreading sequence, would be directly with other slave agents and not through the master agent 62. Non-authorized slave agents, such as the work station 78 and the mobile PCs 80, 82 are not included in the authorized network and would not be able to receive, store and utilize the spreading sequence generated by the master agent 62.

A system level functional diagram for the master agent is illustrated in FIG. 7. The master agent generates the spreading sequences used for the CDMA communication and delivers them to the authorized slave agents using asymmetric or symmetric cryptography. However, it is important to note that the manner in which the spreading sequences are transmitted from the master agent to the slave agents, as well as the type of cryptography which would be employed, are not crucial to the present invention. For example, the master agent could be a member of several communications systems. In this instance, the master agent would potentially generate and transmit saved spreading sequences at virtually the same time. The master agent could be provided with a plurality of transmit and receive modules each having a separate antenna for transmitting these different spreading sequences virtually simultaneously. Similarly, a slave agent could also be included in more than one communications system, each system operating with different spreading sequences generated by one or more master agents. In this case, the slave agent could also be provided with more than one transmit and receive module and with separate antennas. Alternatively, even if a master agent and a slave agent are participating in several communications systems, the spreading sequence transmitted by the master agent and received by the appropriate slave agents could be multiplexed, necessitating only a single transmit module, a single receive module and a single antenna.

The master agent would include a control module 84 controlling the operation of the master agent. A spread sequence crypto-module 90 is bilaterally connected to the control module 84. The module 90 would generate a spreading sequence in conjunction with instructions received or generated by the control module 84. The spread sequence crypto-module 90 is provided with a policy file for controlling its operation. The policy defines the methods/algorithms used to generate a particular spreading sequence such as, but not limited to, Barker codes, Gold codes, etc. This policy would also be provided with a manner for determining when additional and new spreading sequences should be transmitted from the master agent to the slave agents in the communication system.

A user control interface module 86 is in bilateral communication with the control module 84. The purpose of the user module 86 is to allow the control module to select a particular security policy for the spreading sequence crypto-module.

An authentication/encryption module 94 is in bilateral communication with the control module 84 and will allow the spreading sequence generated by the master agent to be encrypted when it is transmitted to each of the slave agents. Once received, the spread sequence would be decrypted by each of the slave agents utilizing known technology. The user control interface 86 would be utilized to select security policy for the authentication/encryption module 94.

A database 88 is bilaterally connected to the control module 84 or, alternatively, could be provided within the control module 84. This database is used to store the various security keys, as well as past and present spreading sequences generated by the spread sequence crypto-module 90 and transmitted by the master agent to the slave agents. One or more transmit modules 96 are connected to the control module 84. The transmit module spreads the outgoing signal with the encrypted or non-encrypted spreading sequence produced by the spread sequence crypto-module 90 under the control of the control module 84. Each transmit module can use a unique spreading sequence. As shown in FIG. 7, the authentication/encryption module is also connected to the transmit module 96.

The control module 84 is bilaterally connected to one or more receiver modules 92. These receiver modules receive incoming signals from a transmission medium and despread received data with the spreading sequence sent from the control module. One or more receiver modules would be in communication with the control module with each of the receiver modules using its own unique spreading sequence. The receiver module would also receive communication from slave agents new to the system or slave agents which must be rebooted into the system.

Although the master agent 62, shown in FIG. 6, is used to control a single communications network, as will be explained later, a single master agent could be used to control the operation of several communications networks. Therefore, the master agent depicted in FIG. 7 would be provided with a plurality of both receiver modules 92 and transmit modules 96. A single receiver module and a single transmit module would be employed for each of the communications network controlled by that master agent. If a master agent would only control a single communications network, only a single receiver module and a single transmit module would be required. Alternatively, a single receiver module and a single transmit module could be provided to a master agent controlling more than one communications system. In this instance software or hardware provided in the control module 84 and database 88 would be used to control the operation of the master agent for each of the communications systems.

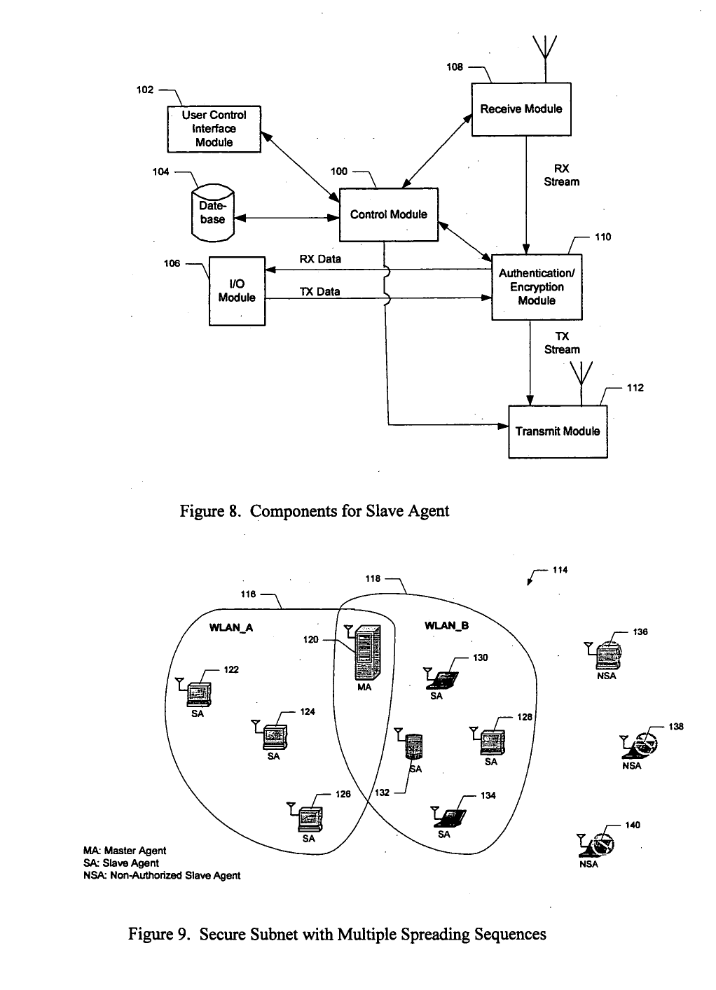

The components for a typical slave agent illustrated in FIG. 6 are provided in FIG. 8. The slave agent receives and stores the spreading sequence from the master agent and uses this spreading sequence to spread the out-going traffic signal before transmission to other authorized slave agents in the communications system, as well as despreading transmissions received by other authorized slave agents.

Operation of the slave agent would be controlled by a control module 100 which would receive communication from one or more of the other slave agents in the network, as well as to transmit information to one or more of the slave agents in the communication system. The control module is bilaterally connected to a user interface module 102 allowing the slave agent to select a master agent, as well as an authentication and encryption methods standard. Furthermore, the user control interface module 102 controls the downloading of necessary security keys from an authentication/encryption module 110. This authentication/encryption module provides the authentication and encryption for spreading sequence updates for each of the slave agents.

The authentication/encryption module transmits RX data to an input/output module 106 and receives TX data from the input/output module 106. A database 104 is connected to the control module 100 or, in the alternative, can be incorporated directly into the control module. This database is used to store security keys, as well as past and present spreading sequences. A receiver module 108 is bilaterally connected to the control module 100 and is used to receive the incoming signal from one or more of the other authorized slave agents in the communications network. Although FIG. 8 shows a single receiver module 108, it is possible for a slave agent to be a participant in more than one secured communication network. If this is the case, a plurality of receiver modules would be used, each with its own current unique spreading sequence.

The slave agent shown in FIG. 8 is provided with one or more transmit modules 112 connected to the control module 100, as well as the authentication/encryption module 110. The transmit module 112 spreads the out-going signal with the spreading sequence sent by the control module and transmits a data signal utilizing a spreading sequence to one or more of the slave agents provided in the secured communication network. As was true with respect to the receiver module 108, since the slave agent can be a participant in more than one secured communications network, a like number of transmit modules 112 would be provided. However, it is noted that with the proper software and hardware included in the slave agent, it is conceivable that only a single receiver module, as well as a single transmit module could be included without limiting the number of secure communications network to which a particular slave agent can belong.

The embodiment shown in FIG. 9 illustrates a communication system 114 including a first WLAN 116 and a second WLAN 118, both of which are serviced by a single master agent 120. The first WLAN 116 is provided with slave agents 122, 124 and 126, all of which are in the form of a workstation. The second WLAN 118 is provided with a workstation 128, a PDA 132 and two mobile PCs 130 and 134. Workstation 136, as well as mobile PCs 138 and 140, would form no part of either of the two WLANs. As is true with respect to the system shown in FIG. 6, additional types of components could also be employed in one or both of the communication systems 116 and 118. The master agent 120 would control the communication within system 116 using a spreading sequence different than the spreading sequence utilized with respect to the second communication system 118. In this system, the master agent 120 could be provided with a plurality of transmit modules and a plurality of receiver modules, whereas the slave agents in systems 116 and 118 need only employ a single receiver module and a single transmit module.

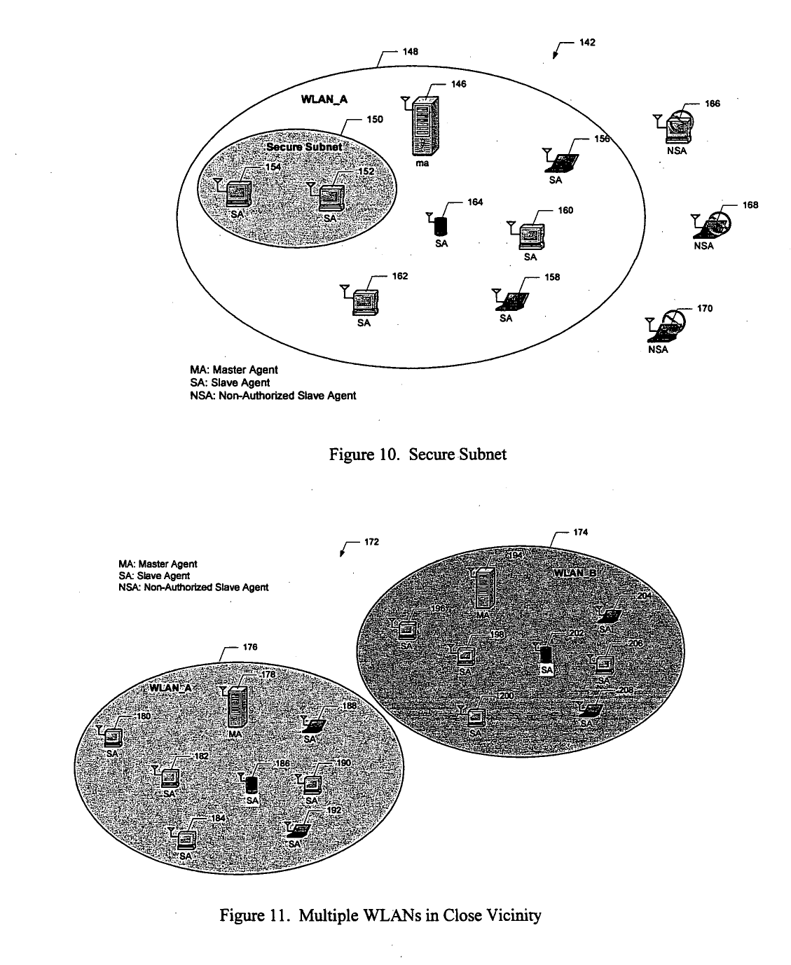

FIG. 10 illustrates a communication network 142 having a first communication network 148, as well as a second subnet 150 completely within the communication network 148. The communication networks 148 and 150 would be controlled by a single master agent 146. Slave agent workstations 152, 154 would reside in both of the communication networks 148 and 150. These workstations 152 and 154 can communicate exclusively with one another using a first spreading sequence, as well as with slave agents 156, 158, 160, 162 and 164 using a second spreading sequence. In this situation, the master agent 146 would, for example, transmit the first spreading sequence to be used only by the units 152 and 154. The master agent 146 would transmit the second spreading sequence to be used exclusively by units 156, 158, 160, 162 and 164. Therefore, all of the units in communication system 148 but not in communication system 150 would be able to communicate with each other, but not with the units in communication system 150. It is possible for the master agent 146 to transmit the same second spreading sequence also to the units included in communication system 150 allowing units 152 and 154 to communicate exclusively with each other using the first spreading sequence, but with the remaining elements in communication system 148 using the second spreading sequence. Units 166, 168 and 170 which are non-authorized slave agents would be unable to communicate with any of the units in both the communications network 148, as well as the elements in communication network 150.

Utilizing different spreading sequences, different WLANs can reside in close vicinity with each other. In this situation, as illustrated in FIG. 11, the communications between the members of each of the different communication network would not be affected by unwanted interference, either intentionally by jamming, or unintentionally. The system 172 shows the use of two communication networks 174 and 176 which operate in close proximity with each, such as being provided on different floors of a single building. Master agent 178 would supply a unique spreading sequence to the members of the network 176 including workstations 180, 182, 184 and 190, PDA 186 and mobile PCs 188 and 192. Similarly, the master agent 194 of the communication network 174 would generate a second spreading sequence to be used by the workstations 196, 198, 200 and 206, as well as PDA 202 and mobile PCs 204 and 208.

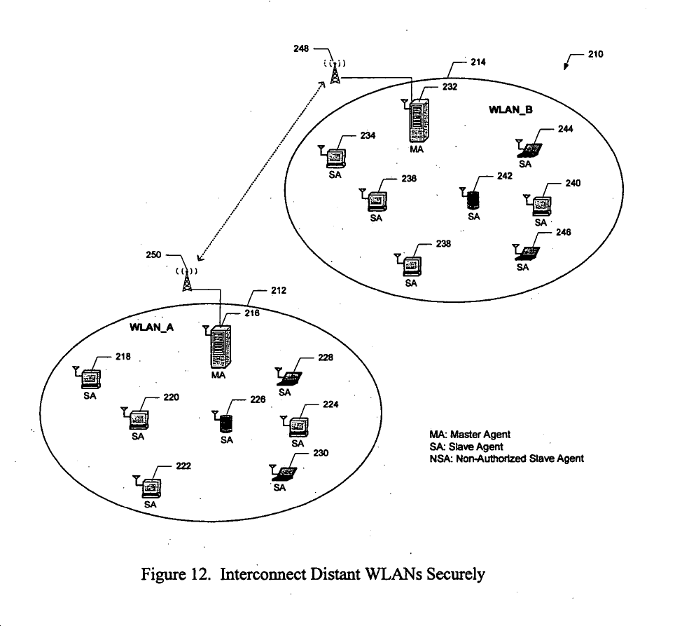

The close vicinity WLANs embodiment can be expanded as shown in FIG. 12 to interconnect WLANs securely to form a wide area wireless network (WAWN). In this scenario, system 210 will be provided with a first WLAN 212 and a second WLAN 214. WLAN 212 is provided with a master agent 216 communicating with workstations 218, 220, 222 and 224, as well as PDA 226 and mobile PCs 228 and 230. The second WLAN 214 is controlled by a master agent 232. The master agent 232 controls elements in the network such as workstations 234, 236, 238 and 240, as well as PDA 242 and mobile PCs 244 and 246. Remote transmitters 248 and 250 are in communication, either by a wireless or a wired system with master agents 232 and 216, respectively. In this manner, communications between the two master agents 216 and 232 would insure that different spreading sequences would be utilized by each of the networks. A similar connection could be made to the two communication systems 174 and 176 shown in FIG. 11 to also insure that differing spreading sequences are always utilized. After describing the various configurations of potential networks, the method of utilizing these networks to provide a secure spreading sequence will not be illustrated.

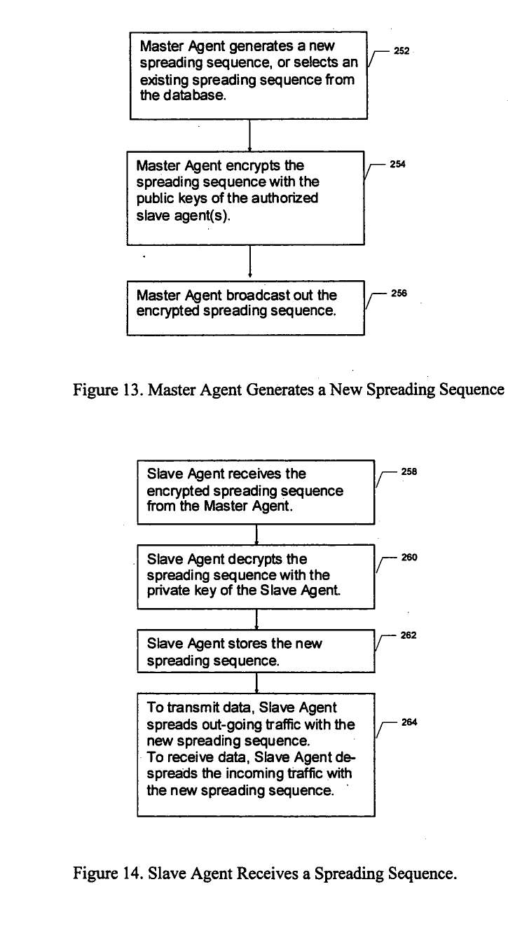

FIG. 13 shows a block diagram whereby a master agent would generate a new spreading sequence. As illustrated in box 252, the master agent would generate a new spreading sequence using the spreading sequence crypto-module or utilize an existing spreading sequence contained in its database. The master agent would then encrypt the spreading sequence with the public keys of the authorized slave agents as shown in box 254. Although the present invention could operate without this encryption step, it is noted that such a step would certainly provide a much more secure communication system. The master agent would then broadcast the encrypted spreading sequence as shown in box 256 to all of the authorized subagents contained in a particular communication system.

Referring to FIG. 14, each of the slave agents would receive the encrypted spreading sequence from the master agent as shown in box 258. The slave agent would decrypt the spreading sequence with the private key of the slave agent in box 260 and then would store an initial or new spreading sequence in its database shown in box 262. The slave agent would then transmit a communication to other slave agents in a secure network using the spreading sequence. Similarly, each slave agent in a network would receive this spread communication and then would despread the communication with the new spreading sequence as shown in box 264.

Generally, the master agent would generate a new spreading sequence by using a known algorithm to randomly generate a spreading sequence or to randomly select a spreading sequence from a table of predetermined spreading sequences. As previously indicated, if the master agent is part of a larger network including a plurality of master agents in communication with one another, the generated or randomly selected spreading sequence could be based in part on the spreading sequences utilized by other communication networks.

The determination of whether to generate a new spreading sequence would be made by weighing various factors. Initially, the master agent might be programmed to periodically generate a new spreading sequence at predetermined intervals, such as once an hour, once a day, once a week, etc. Additionally, the refresh rate, at which time a new spreading sequence is generated, could be an adjustable parameter. The spreading sequence could be changed if it is sensed that RF interference is high, for example, when the number of retransmission of data frames that are reported from a slave agent exceeds a predefined threshold. Therefore, even though the master agent is not directly involved in transmissions between two slave agents in a communication network controlled by that master agent, the master agent would be in communication with one or more of the slave agents for determining whether the system is operating correctly. As indicated hereinabove, if the number of retransmission of data frames reported to the master agent from one or more of the subagents would exceed a predetermined threshold, as determined by the control module provided in the master agent, a new spreading sequence could be generated. Furthermore, a network operator, for security purposes, or for changing the network topology, might manually direct the master agent to generate or randomly select a new spreading sequence. Finally, to insure security of a particular communication network, when one or more slave agents leave that network, it would be imperative to change the spreading sequence.

It is further noted that periodically, a new slave agent would join an existing communications network. When this occurs, a signal would be generated from the new slave agent to be received by the master agent. When this occurs, the master agent would transmit the existing spreading sequence to the new slave agent or would generate or randomly select a new spreading sequence to be transmitted to both the new slave agent, as well as old slave agents in the existing communications network. This same scenario would also occur if one of the existing slave agents has malfunctioned and must be rebooted to rejoin the communications network as an authorized user.

When there is a need to change the network topology, such as creating one or more subnets, the master agent would simply choose different spreading sequences for different groups and deliver them to their respective network devices.

Once a new spreading sequence is generated by the master agent, this new spreading sequence or the key that is used to generate the spreading sequence locally is delivered to the slave agents through asymmetric or symmetric cryptography.

Having thus described the present invention in detail and by reference to preferred embodiments thereof, it will be apparent that modifications and variations are possible without departing from the scope of the invention. For example, although the present invention describes a system and method for providing a secure wireless communications network, the invention could very well be applied to a wired computer network, satellite communications, cellular communications and other forms of communications that have high security and bandwidth requirements.

1. A secure communications system comprising:
a master agent including a control module, a receiver connected to said control module, a transmitter connected to said control module and a spreading sequence device connected to said control module for generating at least one spreading sequence to be transmitted from said master agent; and
at least two first slave agents providing a first communications network with said master agent, each of said slave agents provided with a control module, a receiver connected to aid control module, a transmitter connected to said control module, a memory device for storing at least one spreading sequence transmitted from said master agent, a device for producing an outgoing message spread by at least one spreading sequence and a device for receiving and despreading an incoming message from one of the other said first slave agents.

2. The secure communications system in accordance with claim 1, further including a device in said master agent for randomly generating said spreading sequences.

3. The secure communications system in accordance with claim 1, further including a memory device in said master agent provided with an algorithm for producing said spreading sequences.

4. The secure communications system in accordance with claim 1, further including a memory device storing a plurality of spreading sequences.

5. The secure communications system in accordance with claim 1, wherein said master agent is provided with a device for producing a new spreading sequence on a periodic basis, to be transmitted to each of said slave agents.

6. The secure communications system in accordance with claim 1, wherein each of said slave agents is provided with a device for transmitting to said master agent on a periodic basis a number of faulty transmitted data frames, said master agent producing and transmitting to each of said slave agents a new spreading sequence when said number of said faulty transmitted data frames exceeds a predetermined threshold level.

7. The secure communications system in accordance with claim 1, wherein each of said slave agents is provided with a device for producing an encrypted message for transmission and a device for decrypting a received message.

8. The secure communications system in accordance with claim 1, further including at least two additional slave agents providing a second communications network in conjunction with said master agent, each of said additional slave agents provided with a control module, a receiver connected to said control module, a transmitter connected to said control module, a memory device for storing at least one spreading sequence transmitted form said master agent, a device for producing an outgoing message spread by at least one spreading sequence and a device for receiving and despreading an incoming message from one of the other said additional slave agents;
wherein said master agent produces a first spreading sequence to be used only within said first communications network and said master agent produces a second spreading sequence to be used only within said second communications network.

9. The secure communications system in accordance with claim 8, wherein said second communications network is a complete subset of said first communications network allowing said additional slave agents to receive and transmit messages from slave agents in both said first communications network on said second communicating network.

10. The communications system in accordance with claim 1, wherein said master agent is provided with a device from encrypting said spreading sequence prior to transmitting said spreading sequence to said slave agents and said slave agents provided with a device for decrypting said spreading sequence.

11. The communications system in accordance with claim 1, including at least two additional second slave agents in a second communications network which is a subset of said first communications network, each of said second slave agents provided with a control module, a receiver connected to said control module, a transmitter connected to said control module, a memory device for storing at least two spreading sequences transmitted form said master agent, a device for producing an outgoing message spread by at least one spreading sequence, and a device for receiving and despreading an incoming message from one of the other first and second slave agents; and
wherein said master agent generates a first spreading sequence used exclusively by said second slave agents to communicate within said subset of said first communications network, said master agent further generates a second spreading sequence used by both said first slave agents and said second slave agents.

12. A secure communications system comprising:
a first master agent including a control module, a receiver connected to said control module, a transmitter connected to said control module and a spreading sequence device connected to said control module for generating at least one spreading sequence to be transmitted from said first master agent;
at least two first slave agents providing a first communications network with said first master agent, each of said first slave agents provided with a control module, a receiver connected to said control module, a transmitter connected to said control module, a memory device for storing at least one spreading sequence transmitted from said first master agent, a device for producing an outgoing message spread by at least one spreading sequence and a device for receiving and despreading an incoming message from one of the other said first slave agents;
a second master agent including a control module, a receiver connected to said central module, a transmitter connected to said control module and a spreading sequence device connected to said control module for generation at least one spreading sequence to be transmitted from said second master agent;
at least two second slave agents providing a second communications network with said second master agent, each of said second slave agents provided with a control module, a receiver connected to said control module, a memory device for storing at least one spreading sequence transmitted from said second master agent, a device for producing an outgoing message spread by at least one spreading sequence and a device for receiving and despreading an incoming message from one of the other said second slave agents; and
a third communications device between said first and second master agents, said third communications device transmitting information between said first and second master agents.

13. The secure communications system in accordance with claim 12, wherein each of said first and second master agents provided with a means for ensuring that the spreading sequences generated by said first master agent is different than the spreading sequences generated by said second master agent.

14. A method for transmitting messages in a communications system including a master agent and at least two slave agents, comprising the steps of:
generating a first spreading sequence in said master agent;
transmitting said first spreading sequence from said master agent to said slave agent;
storing said first spreading sequence in a memory device provided in each of said slave agents;
producing an outgoing message in one of said slave agedness spread by said first spreading sequenced; and
transmitting said outgoing message from one of said slave agents to at least one other slave agent.

15. The method for transmitting messages in accordance with claim 14, further including the step of periodically generating and transmitting additional spreading sequences from said master agent to said slave agents to be substituted for said first spreading sequences.

16. The method for transmitting messages in accordance with claim 15, further including the step of randomly generating each of said spreading sequences.

17. The method for transmitting messages in accordance with claim 15, further including the step of generating each of said spreading sequences using a particular algorithm.

18. The method for transmitting messages in accordance with claim 15, further including the steps of:
sensing a number of faulty transmitted data frames;
comparing said faulty transmitted data frames with a predetermined threshold level; and
producing and transmitting a new spreading sequence from said master agent to each of said slave agents when said predetermined threshold level is exceeded.

19. The method for transmitting messages in accordance with claim 14, including the step of encrypting said outgoing message.
